(19) United States
(12) Patent Application Publication
(10) Pub. No.: US 2026/0037801 A1
(43) Pub. Date: Feb. 5, 2026

(54) FILTERING DATA FOR KNOWLEDGE DISTILLATION

(71) Applicant: Google LLC, Mountain View, CA (US)

(72) Inventors: Fotios Iliopoulos, New York, NY (US); Gaurav Menghani, Santa Clara, CA (US); Erik Nathan Vee, Hillsborough, CA (US); Cenk Baykal, Brooklyn, NY (US); Khoa Trinh, San Jose, CA (US)

(21) Appl. No.: 19/285,543

(22) Filed: Jul. 30, 2025

(30) Foreign Application Priority Data
Jul. 31, 2024 (GR) 20240100553

(51) Int. Cl. G06N 3/08

(52) U.S. Cl. CPC G06N 3/08

(57) ABSTRACT

Methods, systems, and apparatus for training a student neural network to perform a task. In one aspect, a method includes obtaining a training dataset including multiple training inputs, generating a filtered training dataset including a subset of the multiple training inputs, comprising, for each of the one or more training inputs, processing the training input using a teacher neural network to generate a respective teacher output for the task, determining an uncertainty measure for the training inputs that represents an uncertainty of the teacher neural network in generating the respective teacher output, and determining whether to filter out the training input based on the uncertainty measure. The method further includes training the student neural network using the filtered training dataset.

### CROSS-REFERENCE TO RELATED APPLICATION

This application claims priority under 35 U.S.C. § 119 (a) to Greek application Ser. No. 20/240100553, filed in the Greek Patent Office on Jul. 31, 2024. The disclosure of the foregoing application is herein incorporated by reference in its entirety.

### BACKGROUND

This specification relates to training a neural network to perform a machine learning task.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a student neural network to perform a task using a filtered training dataset.

In particular, to perform this training, the system makes use of a teacher neural network configured to perform the same task as the student neural network. The system can process training inputs from an original dataset using the teacher neural network to generate a respective teacher output for each of the training inputs. The system can then generate the filtered training dataset by determining whether to filter out one or more training inputs from the original data set based on an uncertainty measure for the corresponding teacher output of each training input. The uncertainty measure for a given teacher output represents an uncertainty of the teacher neural network in generating the given teacher output.

Once the system has generated the filtered training dataset, the system can train the student neural network through distillation using the teacher outputs generated by the teacher neural network for the training inputs in the filtered data set.

In some implementations, training the student neural network using the filtered training dataset includes training the student neural network through distillation from the multiple teacher outputs generated by the teacher neural network pre-trained on the task.

In some implementations, determining the uncertainty measure of the training input includes determining the uncertainty measure by calculating a confidence probability distribution using an exponential function.

In some implementations, determining the uncertainty measure of the training input by calculating the confidence probability using an exponential function includes selecting a value as the base of the exponential function, where the value is a percentage of the training dataset to be filtered out based on an accuracy of the teacher neural network on the training dataset. The exponential function can include a negative exponential of a combination of (i) a confidence metric for the respective training input and (ii) a confidence metric for the training dataset. The confidence metric for the respective training input is a margin score that represents a difference of two confidence probabilities of the confidence probability distribution.

In some implementations, training the student neural network through distillation from the multiple teacher outputs generated by the teacher neural network includes processing each of the training inputs of the filtered training dataset using the student neural network to generate a respective student output for the task for each of the training inputs, computing a gradient with respect to a loss function that measures a loss between (i) the student output for the training input and (ii) the teacher output for the training input, and updating student parameters of the student neural network using the gradient.

In some implementations, the method further includes, after training the student neural network, deploying the student neural network on a device.

Particular embodiments of the subject matter described in this specification can be implemented as to realize one or more of the following advantages.

In existing distillation techniques, a system can perform knowledge distillation by distilling a teacher neural network to a student neural network. As a particular example, the system can leverage the teacher neural network to train a smaller student neural network that can be more efficiently deployed on a device. For example, the student neural network can be deployed in a computing environment with limited computational budget where the teacher neural network could not be effectively deployed (e.g., because the parameters of the teacher neural network would not fit in the memory of the device or because the latency of the teacher neural network would be too large when deployed on the device).

In some implementations, a system can use unlabeled training data for semi-supervised knowledge distillation. In particular, the system can use the teacher neural network to generate “soft” teacher outputs for training examples of an unlabeled training dataset. For example, in the case of a classification task, a system can process inputs of the unlabeled dataset to generate respective teacher pseudo-labels for each input. The system can then use the teacher outputs in distillation for training the student neural network. However, the teacher outputs for some inputs may be noisy or inaccurate, which can harm the effectiveness of the training and result in suboptimal performance of the student neural network.

To account for this, techniques described in this specification distill knowledge to the student neural network by training on a generated filtered dataset. In particular, the system can filter out training examples that are likely to be mislabeled by the teacher neural network based on a metric that represents an uncertainty of the teacher neural network in generating the respective teacher output.

During training of the student neural network, the system can leverage the filtered dataset to improve the quality of training because the teacher outputs for the inputs in the filtered dataset have a higher likelihood of being correct, i.e., by virtue of filtering outputs and inputs that are likely to be inaccurate as part of generating the filtered dataset. Thus, by training the student neural network on the higher quality filtered dataset, the student neural network can be trained to perform a task more accurately in comparison with a student neural network trained directly on an unfiltered dataset.

Additionally, filtering the training examples based on the uncertainty measure allows the system to select a percentage of the dataset to be filtered out, rather than to simply filter out examples with a high level of uncertainty. This allows for a greater level of diversity in the training examples, as filtering out examples merely based on uncertainty or entropy can result in filtering out an excessive proportion of the examples of a particular class or type for a task.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of a system for training a student neural network to perform a task using a filtered training dataset.

FIG. 2 is a block diagram of a data filtering system and a distillation training system.

FIG. 3 is a flow diagram of an example process for training a student neural network to perform a task using a filtered dataset.

FIG. 4 is a diagram of the results of training a student neural network to perform a task using a filtered training dataset.

Like reference numbers and designations in the various drawings indicate like elements.

### DETAILED DESCRIPTION

This specification describes a system implemented as computer programs on one or more computers in one or more locations that trains a student neural network to perform a task (e.g., a machine learning task).

Generally, the machine learning task that the student neural network is trained to perform can be an appropriate classification task. As used in this specification, a classification task is any task that requires the neural network to generate an output that specifies one or more respective score distributions over a plurality of categories and to then select one or more highest scoring categories from each of the score distributions as a “classification” for the network input.

One example of a classification task is image classification, where the input to the neural network is an image, i.e., the intensity values of the pixels of the image, the categories are object categories, and the task is to classify the image as depicting an object from one or more of the object categories.

Another example of a classification task is image segmentation, where the input to the neural network is an image, i.e., the intensity values of the pixels of the image, the categories are object categories, and the task is to classify each pixel in the image as depicting an object from one or more object categories. For example, the object categories can include a “background object” category that includes the background of the scene and one or more categories corresponding to possible foreground objects.

Another example of a classification task is text classification, where the input to the neural network is text and the task is to classify the text as belonging to one of the categories. One example of such a task is a sentiment analysis task, where each category corresponds to different possible sentiments of the task. Another example of such a task is a reading comprehension task, where the input text includes a context passage and a question and the categories each correspond to different segments from the context passage that might be an answer to the question. Other examples of text processing tasks that can be framed as classification tasks include an entailment task, a paraphrase task, a textual similarity task, a sentiment task, a sentence completion task, a grammaticality task, and so on.

Another example of a classification task is machine translation, where the input to the neural network is text in one language and the task is to generate scores for text in a target language that represent the likelihood that the text in the target language is a translation of the input text.

Other examples of classification tasks include speech processing tasks, where the input to the neural network is audio data representing speech. Examples of speech processing tasks include speech recognition (where the categories are different possible transcriptions of the speech), language identification (where the categories are different possible languages for the speech), hotword identification (where the categories indicate whether one or more specific “hotwords” are spoken in the audio data), and so on.

Another example of a classification task is text-to-speech (where the classes are different possible utterances of the text).

As another example, the task can be a health prediction task, where the input is a sequence derived from electronic health record data for a patient and the categories are respective predictions that are relevant to the future health of the patient, e.g., a predicted treatment that should be prescribed to the patent, the likelihood that an adverse health event will occur to the patient, or a predicted diagnosis for the patient.

As another example, the task can be an agent control task, where the input is one or more observations or other data characterizing states of an environment, and the output defines score distributions over actions to be performed by the agent in response to the most recent observation. The agent can be, e.g., a real-world or simulated robot, a control system for an industrial facility, or a control system that controls a different kind of agent.

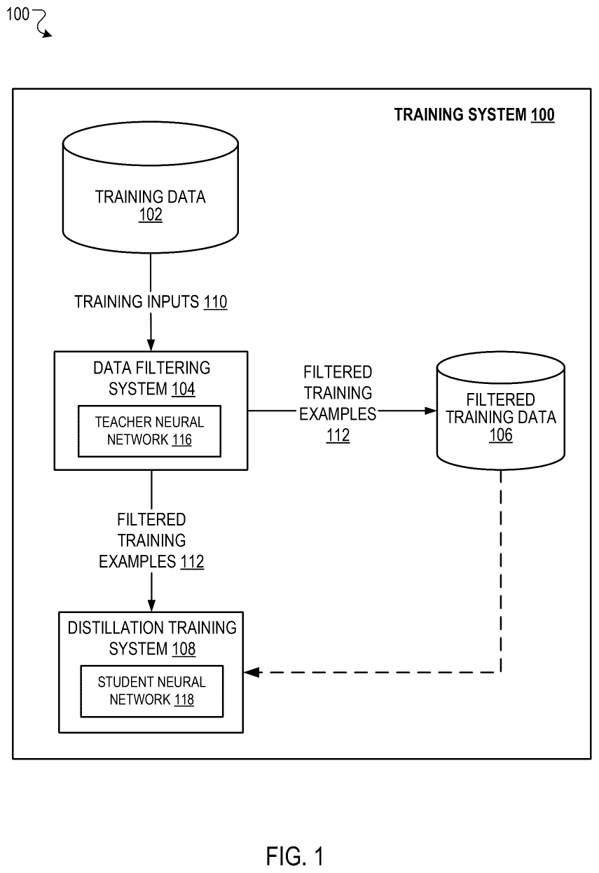

FIG. 1 shows a training system 100. The system 100 (e.g., the training system 100) is an example of a system implemented as computer programs, one or more computers in one or more locations, in which the systems, components, and techniques described below can be implemented.

The system 100 is configured to train a student neural network 118 to perform a task using an already-trained teacher neural network 116. In particular, the system 100 generates a filtered dataset (e.g., filtered training examples 112) using the teacher neural network 116, and the system 100 trains the student neural network 118 on the filtered training examples 112. The system 100 includes a data filtering system 104 and a distillation training system 108.

The student neural network 118 is configured to receive an input and to process the input in accordance with a set of parameters (e.g., student parameters) to generate an output for the input for the task. As described above, the task can be any of a variety of machine learning tasks.

The student neural network 118 can have any appropriate architecture that allows the neural network to perform the particular machine learning task (e.g., to map inputs of the type and dimensions required by the task to outputs of the type and dimensions required by the task).

As one example, when the inputs are images, the student neural network 118 can be a convolutional neural network, e.g., a neural network having a ResNet architecture, an Inception architecture, an EfficientNet architecture, and so on, or a Transformer neural network, e.g., a vision Transformer.

As another example, when the inputs are text, features of medical records, audio data or other sequential data, the student neural network 118 can be a recurrent neural network, e.g., a long short-term memory (LSTM) or gated recurrent unit (GRU) based neural network, a convolutional neural network, or a Transformer neural network.

As another example, the student neural network 118 can be feed-forward neural network, e.g., an MLP, that includes multiple fully-connected layers.

The teacher neural network 116 is configured to receive an input and to process the input in accordance with a set of parameters (e.g., teacher parameters) to generate an output for the input for the task. As described above, the task can be any of a variety of machine learning tasks.

The teacher neural network 116 can have any appropriate architecture that allows the neural network to perform the particular machine learning task (e.g., to map inputs of the type and dimensions required by the task to outputs of the type and dimensions required by the task).

As one example, when the inputs are images, the teacher neural network 116 can be a convolutional neural network, e.g., a neural network having a ResNet architecture, an Inception architecture, an EfficientNet architecture, and so on, or a Transformer neural network, e.g., a vision Transformer.

As another example, when the inputs are text, features of medical records, audio data or other sequential data, the teacher neural network 116 can be a recurrent neural network, e.g., a long short-term memory (LSTM) or gated recurrent unit (GRU) based neural network, a convolutional neural network, or a Transformer neural network.

As another example, the teacher neural network 116 can be feed-forward neural network, e.g., an MLP, that includes multiple fully-connected layers.

As described above, the data filtering system 104 makes use of the teacher neural network 116 in generating the filtered training examples 112 for training the student neural network 118. The student neural network 118 and the teacher neural network 116 are generally both neural networks that are configured to perform the same machine learning task. The teacher neural network 116 has been pre-trained to perform the machine learning task (e.g., has been trained on the set of training data 102 that can be used to train the student neural network 118 or on a different set of training data to optimize an objective function for the machine learning task using conventional machine learning techniques).

In some cases, the student neural network 118 and the teacher neural network 116 have the same architecture and, therefore, the same number of parameters. For example, both neural networks can be convolutional neural networks, self-attention-based neural networks (Transformers), or recurrent neural networks. In these cases, the system 100 trains the student neural network 118 to have improved performance relative to the teacher neural network 116 even though the two have the same architecture.

In some other cases, however, the two neural networks have different architectures, with the teacher neural network 116 having a larger number of parameters than the student neural network 118. In these cases, a larger, less computationally efficient teacher neural network 116 is used to improve the performance of a smaller, computationally efficient student neural network 118. For example, both neural networks can be convolutional neural networks, self-attention-based neural networks (Transformers), or recurrent neural networks, but with the student neural network 114 having fewer parameters because of having fewer layers, operating on internal representations that have smaller sizes (e.g., fewer output filters in the case of a convolutional layer or smaller dimensions of the queries, keys, and values for a self-attention sub-layer in a Transformer), or both.

To perform the training of the student neural network, the system receives training data 102. The training data 102 includes multiple training inputs 110. The training inputs 110 can be any appropriate type of inputs for a task as described above.

Prior to performing the training, the data filtering system 104 uses the training data 102 to generate filtered training data 106 that includes multiple filtered training examples 112.

The filtered training examples 112 can include the training inputs 110 (e.g., a filtered subset of the training inputs 110) and respective teacher outputs (e.g., a filtered teacher outputs) generated by a teacher neural network (e.g., the teacher neural network 118).

The system 100 uses the data filtering system 104 to generate the filtered training examples 112 by processing the training inputs 110. The system 100 then uses the distillation training system 108 to train the student neural network 118 using the filtered training examples 112.

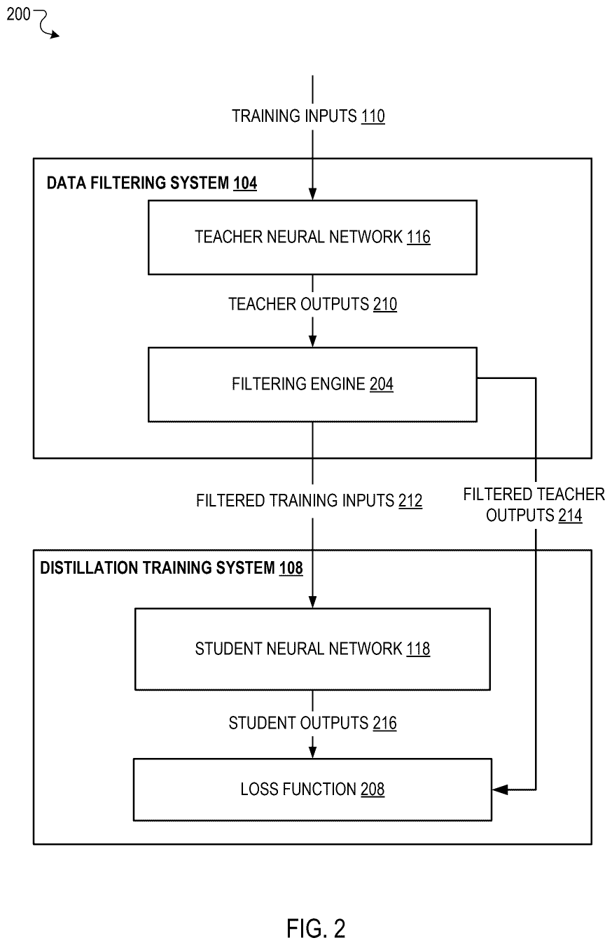

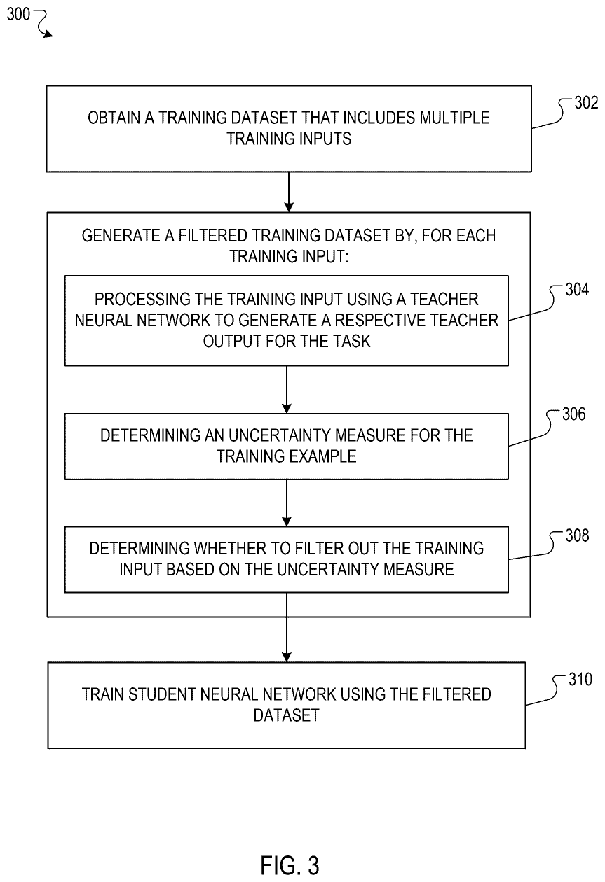

To generate the filtered training examples 112, the system 104 processes each training input 110 using the teacher neural network 116 to generate a respective teacher output. The system 104 then determines an uncertainty measure for each of the teacher outputs, and system 104 uses the uncertainty measures for the teacher outputs to filter out one or more training inputs 110, as described in further detail below with reference to FIGS. 2 and 3.

The system can then output the filtered training examples 112 to the distillation training system 108. The filtered training examples 112 include the training inputs that were not filtered out (e.g., filtered training inputs) and the corresponding teacher output (e.g., filtered teacher outputs). In some examples, the system can store the filtered training examples 112 as part of the filtered training data 106. For example, the system can store sets of filtered data, and the system can provide the filtered training data 106 to the distillation training system 108.

The distillation training system 108 performs knowledge distillation of the filtered teacher outputs to train the student neural network 118. In particular, the system 100 trains the student neural network 114 on a respective batch of filtered training examples 112 at each of multiple training steps, as described in more detail below with reference to FIGS. 2 and 3.

Once the system has trained the student neural network 118, the student neural network 118 can be deployed. For example, the student neural network 118 can be deployed on a device, such as a mobile device, or can be embedded within a robot or a vehicle. In another example, the student neural network 118 can be deployed in a data center or other set of multiple devices in parallel. The student neural network 118 can generate new student outputs from new training inputs after deployment.

FIG. 2 shows a data filtering system and a distillation training system.

The data filtering system 104 uses the teacher neural network 202 and a filtering engine 204 to generate the filtered training examples 112. The filtered training examples 112 include the filtered subset of training inputs 110 (e.g., filtered training inputs 212) and the corresponding teacher outputs (e.g., filtered teacher outputs 214).

To perform the training of the student neural network, the data filtering system 104 leverages the teacher neural network 116 to generate a filtered data set from the original dataset (e.g., the unfiltered dataset). In particular, the data filtering system generates “soft” teacher outputs 210 by processing the training inputs 110. The teacher outputs 210 are referred to as “soft” because the teacher outputs 210 include a respective non-zero score for a large number of candidate outputs, such as classes in a classification task. In contrast, a “hard” output includes a score of 1 for a candidate output and zero for the other candidate outputs (e.g., a hard label of the input). The training examples include the training inputs 110 and the respective teacher outputs 210.

The system then generates a probability for each of the training examples by evaluating each training example using an uncertainty measure, where the probability represents the likelihood that the training example will be filtered out from the data set. The uncertainty measure represents an uncertainty of the teacher neural network 118 (e.g., an uncertainty that the teacher neural network is correct in predicting the teacher output of the training example).

In some examples, the uncertainty measure can be an entropy value that measures a level of disorder or uncertainty for the training example. For example, for a classification task, the system can determine an entropy value for each input x, as shown by Equation 1:

$$Entropy ( q ( x ) ) = - {\sum }_{i = 1}^{X} {q ( x )}_{i} log {q ( x )}_{i} \qquad ( 1 )$$

where i represents a possible class for the classification task, and q(x)ᵢ represents the probability assigned to the class i in the teacher output for the training example. In this case, a relatively high entropy value corresponds to a relatively high uncertainty of the teacher output (e.g., an increased likelihood that the teacher neural network has incorrectly classified the training input), whereas a relatively low entropy value corresponds to a relatively high certainty of the teacher output.

In another example, the uncertainty measure can be the complement of, or more generally, inversely proportional to, a margin score between two probabilities of a probability distribution for the training examples, as shown by Equation 2:

$$Uncertainty = 1 - MarginScore \qquad ( 2 )$$

For example, the margin score can be a difference between the two highest probabilities of the probability distribution. In the case where the difference is relatively large, the complement of the margin score can indicate that the teacher neural network is fairly certain in the teacher output, whereas a relatively low difference can indicate that the teacher neural network is not particularly certain in the teacher output.

To determine the training examples to filter out, the filtering engine 204 can determine a confidence probability for each training example x based on the uncertainty measure that assigns a higher probability to training examples that have higher uncertainty measures. For example, the system can determine the probability using Equation 3:

$$p ( x ) = {base}^{- \frac{TeacherUncertainty ( x )}{AverageTeacherUncertainity}} \qquad ( 3 )$$

where the base is a hyperparameter value. The base represents a percentage of the dataset to be filtered out. In some cases, the system can use a fixed value as the base, or the system can determine the value of the base based on a user input. For example, a user can directly provide the value of the base. In another example, the user can specify a target size of the filtered dataset, and the system can determine the corresponding value of the base. For example, the system can use Equation 4 to determine the corresponding value of the base based on the target size of the filtered dataset:

$$Filteredsize ( base ) \sum p ( x ; base ) \qquad ( 4 )$$

where FilteredSize represents the expected specified target size of the filtered dataset and p(x;base) is equal to p(x) in Equation 3 above. The system can perform a search algorithm over potential values to determine the value of the base such that FilteredSize(base) equals the specified target size of the filtered dataset. In particular, the system can iterate through potential values (e.g., 1.1, 1.2, 1.3, etc.). For each potential value, the system computes an expected value of FilteredSize(base) using Equation 4 (e.g., FilteredSize(1.1), FilteredSize(1.2), etc.) until the system determines that the expected value of the FilteredSize(base) satisfies a threshold difference from the specified target size of the filtered dataset. For example, the system can compute mappings for each potential value that include the potential value and the expected value of FilteredSize(base) (e.g., a mapping of a base of 1.1 to a FilteredSize(base) of 99.5%.

The system can select any appropriate range of potential values (e.g., {1.1, 1.2, . . . 2}) using any appropriate mathematical technique. For example, the system can select a uniformly random sample of training examples of size N (e.g., 10,000 training examples), and the system can perform the search over the sample of training examples.

TeacherUncertainty represents the uncertainty measure of the teacher output for each training example x. Average TeacherUncertainty represents the average uncertainty measure of the training examples.

To perform the filtering, the filtering engine 204 removes (e.g., filters) each training example with a probability equal to p(x), and the filtering engine 204 keeps (e.g., refrains from filtering) training examples with a probability of 1−p(x). The filtering engine 204 can then output the filtered training examples, which include the filtered training inputs 212 and the respective filtered teacher outputs 214, to the distillation training system 108 for training the student neural network.

As such, the filtering engine 204 can filter out relatively “uncertain” training examples based on the percentage of training examples to be filtered out and their respective probabilities. Thus, by generating the filtered training examples, the system can ensure that the student neural network is trained on high quality training data from the teacher neural network because the system filters the training examples based on a certainty of the teacher neural network in generating the corresponding teacher output.

Additionally, the system can ensure that the student neural network is trained on relatively diverse training data because, instead of simply filtering out training examples based on a threshold (e.g., an uncertainty threshold) the system filters out the training examples probabilistically based on the probability of each training example to be filtered out. For example, in a classification task, a particular class of training examples may be associated with a relatively high level of uncertainty. By filtering out a percentage of the training examples, the system can ensure with higher likelihood that a variety of classes will be present in the training examples, including training examples with high uncertainty, rather than simply filtering out the particular class of training examples associated with high uncertainty.

In order to train the student neural network, the system trains the student neural network 114 on the filtered training inputs 212 and the filtered teacher outputs 214 at each of multiple training steps. In particular, at any given training step, the system 100 uses the student neural network 114 to generate a student output 216 for each filtered training input 212. The distillation training system 108 can then use a loss function 208 to measure error (e.g., loss) between corresponding filtered teacher outputs 214 and student outputs 216.

The loss function 208 can measure a difference between, for each filtered training input 212, the student output 216 generated for the training inputs and the filtered teacher output 214 generated for the training input. In some examples, the loss function 208 can include a cross-entropy loss, a KL divergence, or any other appropriate measure of the difference between two score distributions (e.g., the student output and the teacher output). In some examples, the loss function 208 includes additional terms, such as a regularization term that penalizes (e.g., discourages) the student neural network 114 from generating student outputs 216 that deviate from the filtered teacher outputs 214. In some other examples, such as the case where ground truth labels for the training inputs are available, the loss function 208 can include a term that represents a loss between the student output 216 and the ground truth label.

The system 100 can use the loss function to compute a gradient with respect to the student parameters of the student neural network 118. The distillation training system can use the gradient to update and refine the student parameters of the student neural network 118.

That is, the system can apply an appropriate optimizer, e.g., Adam, Adafactor, stochastic gradient descent, a learned optimizer, or another appropriate optimizer, to the gradient to generate an update and then applies the update to the current student parameters of the student neural network 118. For example, the system can apply the update by adding or subtracting the update from the values of the current student parameters.

The system can repeatedly perform training iterations to repeatedly update the parameters of the student neural network until a termination criterion has been satisfied, e.g., until a threshold number of iterations have been performed, until a threshold amount of wall clock time has elapsed, or until the values of the network parameters have converged.

FIG. 3 is a flow diagram of an example process 300 for training a student neural network to perform a task using a filtered dataset. For convenience, the process 300 will be described as being performed by a system of one or more computers located in one or more locations. For example, a system, e.g., the system 100 of FIG. 1, appropriately programmed in accordance with this specification, can perform the process 300.

The system obtains a training dataset (e.g., an original training dataset) that includes multiple training inputs (302). For example, the original training dataset can be a largely unlabeled training dataset for a classification task, where the training inputs can be text, images, audio, or a combination thereof.

The system can then generate a filtered training dataset (e.g., a filtered version of the original training dataset) for training the student neural network 118.

In particular, for each training input of the original dataset, the system can process the training input using a pre-trained teacher neural network to generate a respective teacher output for the task (304). For example, each teacher output can include a probability distribution over a set of classes for the classification task.

The system can determine an uncertainty measure for each training example (306). The training example includes the training input and the respective teacher output. The uncertainty measure represents a probability that the training example with be filtered out from the dataset. For example, the system can determine the uncertainty measure by determining an entropy value of the training examples, as shown by Equation 1 above. In another example, the system can determine the uncertainty measure by calculating a complement of a margin score for multiple training examples, as shown by Equation 2 above.

The system determines whether to filter out each training input based on the uncertainty measure for the training input (308). The system determines a probability distribution using an exponential function of the uncertainty metric for the training example, as shown by Equation 3 above.

In particular, the system can generate a confidence probability for each training example based on the training input and the teacher output. The confidence probability represents a probability that the system will filter out the particular training example. Additionally, the probability includes a base that represents a percentage of the dataset to be filtered out.

Based on the probability, the system determines whether to filter out one or more training inputs and the respective pseudo-labels. In particular, the system removes each training example with a probability equal to the determined probability. The training examples that are not filtered out are part of the filtered dataset.

The system can then train the student neural network using the filtered dataset (310), e.g., as described above with reference to FIG. 2.

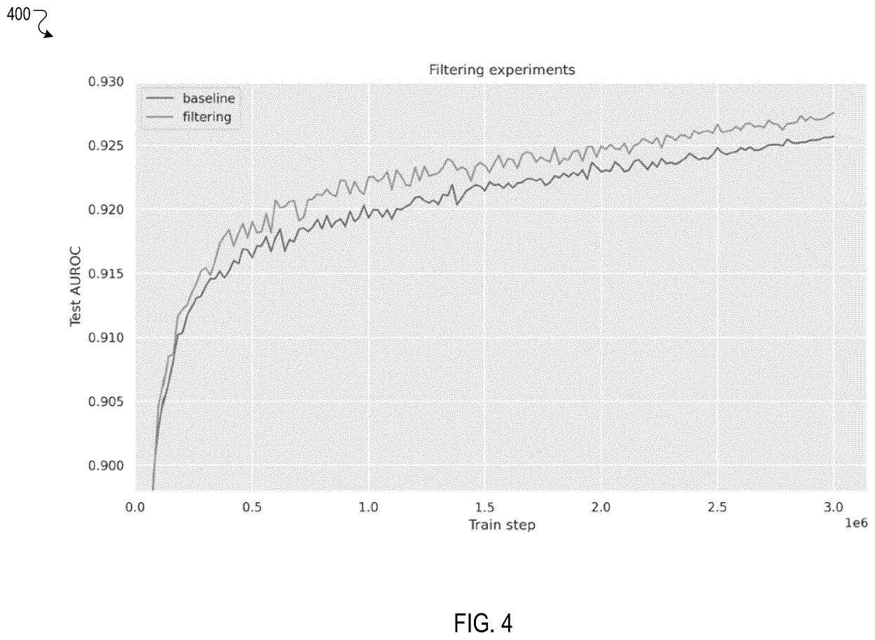

FIG. 4 is a diagram of the results of training a student neural network to perform a task using a filtered training dataset as described in this specification.

The graph of FIG. 4 illustrates the performance of training computed using an area-under-the-curve (AUC) metric that measures the quality of training the student neural network based on the student outputs at multiple training steps. In particular, the student neural network is configured as a classifier neural network for a classification task.

In particular, the graph shows the performance of a pre-existing baseline procedure in training the neural network, and the described procedure of training using a filtered dataset (e.g., 5% filtered dataset). As shown, the filtering technique results in improved training of the student neural network and improved generation of accurate student outputs at multiple training steps.

Thus, by implementing the described filtering techniques to train a student neural network on the filtered dataset, the system can train a student neural network to perform a task more accurately in comparison with other conventional techniques.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training a student neural network to perform a task, the method comprising:
obtaining a training dataset comprising a plurality of training inputs;
generating a filtered training dataset comprising a subset of the plurality of training inputs, comprising, for each of the one or more training inputs:
processing the training input using a teacher neural network to generate a respective teacher output for the task,
determining an uncertainty measure for the training input that represents an uncertainty of the teacher neural network in generating the respective teacher output; and
determining whether to filter out the training input based on the uncertainty measure; and
training the student neural network using the filtered training dataset.

2. The method of claim 1, wherein training the student neural network using the filtered training dataset comprises:
training the student neural network through distillation from the plurality of teacher outputs generated by the teacher neural network pre-trained on the task.

3. The method of claim 1, wherein determining the uncertainty measure for the training input comprises:
determining the uncertainty measure by calculating a confidence probability distribution using an exponential function.

4. The method of claim 3, wherein determining the uncertainty measure by calculating a confidence probability distribution using an exponential function comprises:
selecting a value as the base of the exponential function, wherein the value is a percentage of the training dataset to be filtered out based on an accuracy of the teacher neural network on the training dataset.

5. The method of claim 3, wherein the exponential function includes a negative exponential of a combination of (i) a confidence metric for the respective training input and (ii) a confidence metric for the training dataset.

6. The method of claim 5, wherein the confidence metric for the respective training input is a margin score that represents a difference of two confidence probabilities of the confidence probability distribution.

7. The method of claim 2, wherein training the student neural network through distillation from the plurality of teacher outputs generated by the teacher neural network comprises:
processing each of the training inputs of the filtered training dataset using the student neural network to generate a respective student output for the task for each of the training inputs;
computing a gradient with respect to a loss function that measures a loss between (i) the student output for the training input and (ii) the teacher output for the training input; and
updating student parameters of the student neural network using the gradient.

8. The method of claim 1, further comprising:
after training the student neural network, deploying the student neural network on a device.

9. A system comprising:
one or more computers; and
one or more storage devices storing instructions that, when executed by the one or more computers, cause the one or more computers to perform operations comprising:
obtaining a training dataset comprising a plurality of training inputs;
generating a filtered training dataset comprising a subset of the plurality of training inputs, comprising, for each of the one or more training inputs:
processing the training input using a teacher neural network to generate a respective teacher output for the task,
determining an uncertainty measure for the training input that represents an uncertainty of the teacher neural network in generating the respective teacher output; and
determining whether to filter out the training input based on the uncertainty measure; and
training the student neural network using the filtered training dataset.

10. The system of claim 9, wherein training the student neural network using the filtered training dataset comprises:
training the student neural network through distillation from the plurality of teacher outputs generated by the teacher neural network pre-trained on the task.

11. The system of claim 9, wherein determining the uncertainty measure for the training input comprises:
determining the uncertainty measure by calculating a confidence probability distribution using an exponential function.

12. The system of claim 11, wherein determining the uncertainty measure by calculating a confidence probability distribution using an exponential function comprises:
selecting a value as the base of the exponential function, wherein the value is a percentage of the training dataset to be filtered out based on an accuracy of the teacher neural network on the training dataset.

13. The system of claim 11, wherein the exponential function includes a negative exponential of a combination of (i) a confidence metric for the respective training input and (ii) a confidence metric for the training dataset.

14. The system of claim 13, wherein the confidence metric for the respective training input is a margin score that represents a difference of two confidence probabilities of the confidence probability distribution.

15. One or more computer-readable storage media storing instructions that when executed by one or more computers cause the one or more computers to perform operations comprising:
obtaining a training dataset comprising a plurality of training inputs;
generating a filtered training dataset comprising a subset of the plurality of training inputs, comprising, for each of the one or more training inputs:
processing the training input using a teacher neural network to generate a respective teacher output for the task,
determining an uncertainty measure for the training input that represents an uncertainty of the teacher neural network in generating the respective teacher output; and
determining whether to filter out the training input based on the uncertainty measure; and
training the student neural network using the filtered training dataset.

16. The computer-readable storage media of claim 15, wherein training the student neural network using the filtered training dataset comprises:
training the student neural network through distillation from the plurality of teacher outputs generated by the teacher neural network pre-trained on the task.

17. The computer-readable storage media of claim 15, wherein determining the uncertainty measure for the training input comprises:
determining the uncertainty measure by calculating a confidence probability distribution using an exponential function.

18. The computer-readable storage media of claim 17, wherein determining the uncertainty measure by calculating a confidence probability distribution using an exponential function comprises:
selecting a value as the base of the exponential function, wherein the value is a percentage of the training dataset to be filtered out based on an accuracy of the teacher neural network on the training dataset.

19. The computer-readable storage media of claim 16, wherein the exponential function includes a negative exponential of a combination of (i) a confidence metric for the respective training input and (ii) a confidence metric for the training dataset.

20. The computer-readable storage media of claim 19, wherein the confidence metric for the respective training input is a margin score that represents a difference of two confidence probabilities of the confidence probability distribution.
